(19) United States
(12) Patent Application Publication
(10) Pub. No.: US 2009/0271788 A1
(43) Pub. Date: Oct. 29, 2009

(54) WEB BASED TASK COMPLETENESS MEASUREMENT

(76) Inventors: Alexander W. Holt, New Paltz, NY (US); Joseph M. Lopatka, Katonah, NY (US); Michael E. Moran, Ridgewood, NJ (US); Jeffrey S. Schaffer, Ridgefield, CT (US)

Correspondence Address: HOFFMAN WARNICK LLC, 75 STATE ST, 14 FL, ALBANY, NY, 12207, US

(21) Appl. No.: 12/109,403

(22) Filed: Apr. 25, 2008

(51) Int. Cl. G06F 9/46

(52) U.S. Cl. 718/100

(57) ABSTRACT

A system, method and program product for providing measure the completeness of a task in a web based environment and for providing dynamic marketing and other adaptive behavior based on how far a user has completed the task. A system is provided that includes: a task definition system for associating subsets of documents available via a content delivery system with a plurality of tasks; a tracking system for tracking which documents have been viewed by a user; a task determination system for determining which of the plurality of tasks the user is engaged in performing; and a progress analysis system for analyzing a progress the user has achieved towards completing the task.

### FIELD OF THE INVENTION

This disclosure relates to measuring completeness of a performed web task, and more particularly relates to a system and method of identifying a task being performed by a user, assessing progress of the task, and determining a response.

### BACKGROUND OF THE INVENTION

Unlike a physical store, interactive businesses have difficulty knowing what an individual customer is doing, which prevents them from providing the most effective service to the customer. For instance, in making a large scale purchasing effort of information technology equipment, a user may need to visit a website to thoroughly investigate features such as specifications, compatibility, availability, costs, etc. In such an environment, there may be no typical path that a user follows. Instead, a user may randomly select different content at different times until enough information is gathered to make a purchasing decision. Furthermore, in many cases, a customer may need multiple visits over time to accomplish their task. Given this approach, effectively improving the user experience and marketing effort is a challenge, since the website lacks an understanding of how far a user has progressed in completing his or her task.

Moreover, different users may view the same website content for different tasks. For instance, a technical specification may be utilized by a first user as part of a purchasing decision and used by a second user for technical support purposes. This further complicates the marketing effort in that users performing different tasks need to be marketed to in different manners. Accordingly, an additional challenge is determining how the website can modify its behavior in order to facilitate the completion of the task or influence the outcome of the task in a manner favorable to the marketer.

Consider the case where a user (i.e., customer) is researching the purchase of a personal computer on a vendor's website. The customer might decide to identify and research potential purchase candidates when prompted by a banner ad, or e-mail, or some offline marketing stimulus or completely of their own volition. In the course of such research, the vendor seeks to understand what messages the customer has been exposed to (document impressions) and which ones caused the customer to make forward progress in the purchasing task. For example, marketers routinely track which e-mails are seen by customers (through various mechanisms) and which ones are clicked so that the customer visits the marketer's website. Existing systems use various names for document impressions (e-mails opened, web pages viewed, banner ad impressions, and more), but for the purposes of this disclosure, they are referred to as document impressions for simplicity—when the customer sees the document containing the marketing message, no matter what form that message is in, that's a document impression.

In the course of this research, the customer may need to view a number of web pages about a product, each page containing a different type of information. The customer may be able to view only some of the pages during a single session due to time limitations or interruptions, forcing the customer to make several visits before coming to a purchase decision. When the research is complete, the customer may initiate the purchase transaction from one of the web pages.

A typical website the purchaser might visit has a static organization of the web pages related to the product the purchaser is seeking. If the site is well organized, the customer can locate the pages and choose the specific ones that contain the information that the customer needs to make a decision, as well as the page through which the transaction is initiated. The customer drives the interaction by navigating through the information as he or she see fit. Similarly, e-mail marketing and banner ads are ordinarily static in that they are delivered to all customers. Those few ads that are personalized are shown to all members of a particular demographic or firmographics group, so while segmented, they are not truly personalized to the context of each individual customer. Today's electronic marketing can therefore be considered static.

This static marketing has two serious drawbacks for the marketer, however. First is the need to measure the state of the marketer's business beyond the number and amount of purchases and in a manner more meaningful than the number of pages visited. For example, knowing how many people looked at the product, and how many of them became purchasers allows the marketer to take steps to increase business in predictable ways. If a certain number of sales are required, this knowledge lets the marketer understand how many more people must visit the site to get the desired sales. A more sophisticated approach would examine how many non-purchasers abandoned their research while looking at specific pages, indicating where the pages or the information on them can be improved.

The second drawback of static marketing is that while a human salesperson can “read” which issues concern a prospective purchaser and provide just the right information to address the issues, a static website cannot.

Accordingly, a need exists for a more robust process for analyzing tasks being performed by a user.

### SUMMARY OF THE INVENTION

The present disclosure relates to a system, method and program product for determining a task being performed by a user at a website, determining how complete the task is, and for determining an effective marketing response to the user based on task completeness. In one embodiment, there is a system for measuring completeness of a task, comprising: a task definition system for associating subsets of documents available via a content delivery system with a plurality of tasks; a tracking system for tracking which documents have been viewed by a user; a task determination system for determining which of the plurality of tasks the user is engaged in performing; and a progress analysis system for analyzing a progress the user has achieved towards completing the task.

In a second embodiment, there is a method of measuring completeness of a task, comprising: associating subsets of documents available via a content delivery system with a plurality of tasks; tracking which documents have been viewed by a user; determining which of the plurality of tasks the user is engaged in performing; and analyzing a progress the user has achieved towards completing the task.

In a third embodiment, there is a computer readable medium having a computer program product stored thereon for measuring completeness of a task, comprising: program code for associating subsets of documents available via a content delivery system with a plurality of tasks; program code for tracking which documents have been viewed by a user; program code for determining which of the plurality of tasks the user is engaged in performing; and program code for analyzing a progress the user has achieved towards completing the task and for outputting a set of results.

In a fourth embodiment, there is method for deploying a system for measuring completeness of a task, comprising: providing a computer infrastructure being operable to: associate subsets of documents available via a content delivery system with a plurality of tasks; track which documents have been viewed by a user; determine which of the plurality of tasks the user is engaged in performing; and analyze a progress the user has achieved towards completing the task and for outputting a set of results.

In addition, the described solution can thus use information about the customer's activity to suggest the best pages or documents to view at a website. An analysis that shows which pages are most important to a successful purchase can be used to suggest which pages a customer still needs to view to complete a task (defined, e.g., as viewing a set of core documents). A dynamic website is thus provided that can deliver a higher number of sales from the same number of total customers.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having a completeness measurement system in accordance with an embodiment of the present invention.

FIG. 2 depicts a set of characterized documents in accordance with an embodiment of the present invention.

FIG. 3 depicts a set of characterized documents along with an activity history in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

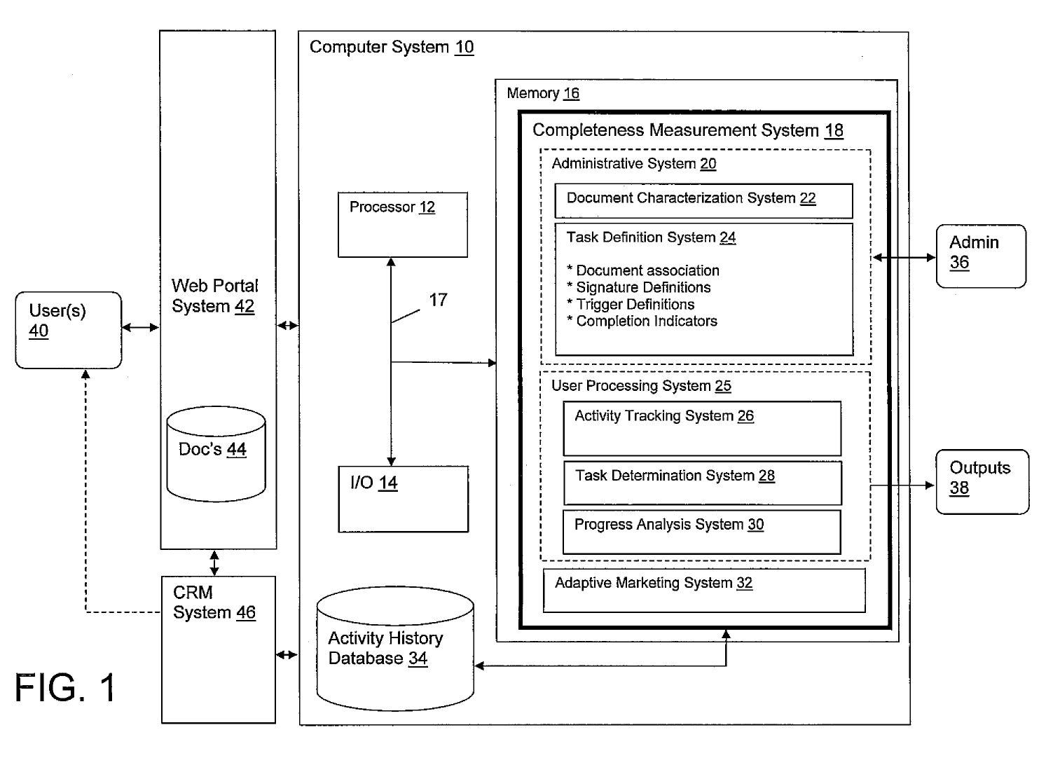

FIG. 1 depicts a computer system 10 comprising an illustrative embodiment of a completeness measurement system 18 that tracks how complete a task is being performed at web portal system 42 by a user 40. Although shown as separate to web portal system 42, it is understood that completeness measurement system 18 could also be partially or completely integrated into the web portal system 42. In addition, it is understood that web portal system 42 may comprise any electronic content delivery system in which there is a desire to track a user's progress at completing a task. In a typical illustrative embodiment, web portal system 42 comprises a website (or site) run by an organization.

In this illustrative embodiment, completeness measurement system 18 tracks which documents 44 a user 40 has viewed or otherwise interacted with at web portal system 42 in completing a predefined task. For example, a user 40 may be responsible for procuring an IT infrastructure from a vendor. Based on some criteria (usage history, assumptions, etc.), it is known that a typical user 40 will view about 25 different documents 44 at the vendor's web site before making a purchasing decision. A document 44 may comprise any type of content item available via the web portal system 42 or related CRM system 46, e.g., a web page, a link, an advertisement, a technical document, a media stream, an email, a mailing, etc. Based on how complete the task is for the user 40, completeness measurement system 18 can implement dynamic marketing strategies via adaptive marketing system 32 to enhance the marketing effort/experience for user 40. Outputs 38 may for instance include reports, analysis, feedback, etc.

Completeness measurement system 18 generally includes an administrative system 20 for configuring or allowing an administrator 36 (e.g., vendor, marketer, etc.) to configure the operational parameters of completeness measurement system 18; a user processing system 25 for analyzing user activities as users 40 engage with web portal system 42; and an adaptive marketing system 32 for providing dynamic marketing services to users 40 as users 40 engage with web portal system 42.

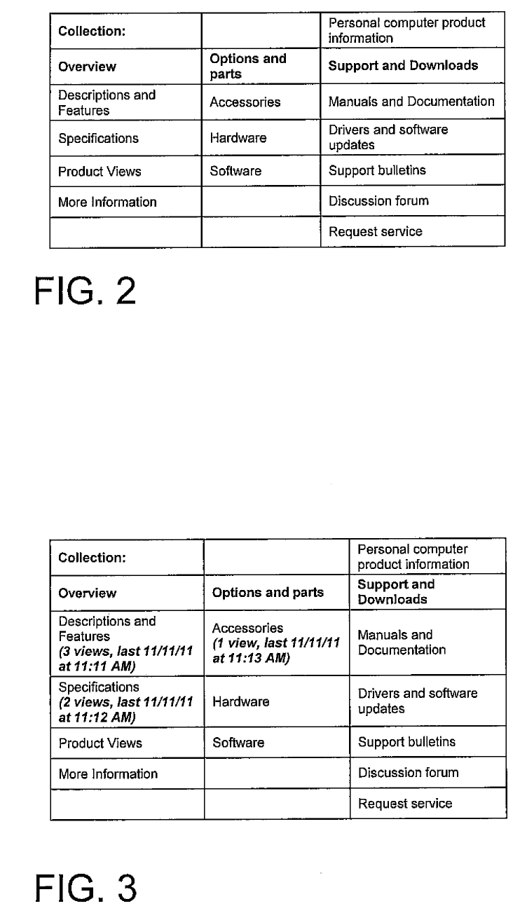

Administrative system 20 generally includes a document characterization system 22 and a task definition system 24. Document characterization system 22 creates an organization of the available documents 44 for a subject that facilitates understanding and analysis. For example, for documents 44 that are about a personal computer, the organization shown in FIG. 2 might be created. In this embodiment, the types of documents available on web portal system 42 relating the personal computers are arranged in matrix. In this case, web portal system 42 includes documents that provide Overviews, Options and Parts, and Support and Downloads. Each of these is further refined, e.g., overview documents include Descriptions and Features, Specifications, Products Views and More Information.

Note that a website may contain many documents or pages about a range of subjects. The tasks that users 40 come to the website to perform may involve multiple subjects or just one. The present invention can be applied in either case, but for the sake of simplifying this discussion, tasks that involve single subjects are described. Note also that a collection of documents about a single subject frequently support more than one task (e.g., purchasing as well as technical support).

Task definition system 24 defines tasks a user 40 might perform while visiting web portal system 42, and may be implemented using any approach. A task may include any goal or set of actions being performed by a user 40 in conjunction with the web portal system 42. Illustrative tasks may include, e.g., purchasing, support, entertainment, education, etc. Tasks can also be defined at any breadth, e.g., “purchasing a server” versus “purchasing a midrange server for less than $20,000 to handle 20-50 users in a small business.” In one embodiment, the administrator 36 (e.g., marketer) can define tasks the web portal system 42 is intended to support. In another embodiment, users 40 can be polled (or other user testing can be performed) to identify the tasks they perform when they visit the site. Other techniques can be employed as well. In a further embodiment, task definitions can be validated by users 40 through a feedback mechanism to ensure that the tasks to be supported by the web portal system 42 correspond well with user expectations.

Once a task is defined, a set of documents are associated with the task. The associated set of documents represent a subset of the documents 44 available through the web portal system 42 that are typically viewed before a user has completed the task. Each such set of documents is preferably tailored to represent the most common pattern of visitor activity within the subject for users 40 who successfully conclude the task. The set of documents may contain sequence information, i.e., which documents are typically viewed before others by task completers. In addition, documents within the set that distinguishes users 40 who successfully conclude the task from users 40 who do not are considered persuasive and may be referred to as “core” documents. The document sets can be determined in any manner.

In one embodiment, the administrator 36 (e.g., marketer) can identify the exact set of documents required to complete a task, e.g., complete a form, read warranty, and download a trial program. In another embodiment, the documents associated with a task can be determined based on user feedback. For instance, by recording documents actually viewed by users 40 when pursuing specific tasks in either a controlled setting such as a user study, or on the live site when users 40 actually complete a task. Analysis of metrics can show which documents are typically viewed by customers before they purchase. Using the personal computer example, it might be found by a particular company that there are seven critical documents that are viewed by 90% of customers before they convert (such as the personal computer home page, the product family page, one or more model pages, one or more specifications pages, a model comparison page, an options page, and the shopping cart page). In addition, other pages may be viewed before conversion by lesser percentages of those that convert (such as accessory pages, options detail pages, and configuration pages). By analyzing each task through the lens of previous customers who have completed the task, a marketer can determine which documents appear to be essential reading before the customer is persuaded. In addition, other documents can be identified as related to the task, but not necessarily part of the core set. These documents could be important to certain segments of customers, but are not as intrinsic to persuasion as the core set.

In a further embodiment, the set of documents associated with a task can be refined over time. In this case, an initial set of documents is defined for a task, and the set is then refined over time based on actual user behavior (for example, in a purchasing task, it may initially be thought that the warranty page is a core document, but later it may be determined that few visitors actually view the warranty page, so it can be removed from the core set of documents).

A task signature can also be defined for each task to offer a means to identify that a user 40 is engaged in a defined task. In one embodiment, the task signature is created automatically by the creation of the task's document set. In this case, the task signature identifies that a user 40 is engaged in a task based simply on whether the documents being viewed are within a particular task's document set.

One or more task triggers can also be defined for a task. Task triggers are events or situations that directly indicate that a user 40 is engaging in a particular task. Defining task triggers allows the administrator 36 to establish set triggers for each task to identify a task, as opposed to discerning the identity of a task by the task signature. Triggers can be any event, including clicking on a link or button on a web page, viewing a document, calling a telecenter, opening or sending an email, etc. A trigger can be as simple as declaring certain documents as being unique to a particular task (such as a compare models page for buying a personal computer). In this case, anyone viewing that single page would automatically be assumed to be performing that task. Triggers are recorded along with the document set associated with each task.

One or more completion indicators can also be defined for a task. This includes, but is not limited to, a task-completion page (e.g., a confirmation page of a web commerce transaction), the selection of a specific link or control on the web page (e.g., a button to request more information), off-line events (e.g., the completion of a purchase through a telecenter), the customer indicating completion (e.g., the customer clicks a “this solved my problem” button on a technical support page), a download, etc. In some situations, the marketer may need to engage in research with customer test subjects to assess at which point they report that the task is complete. Whatever method, listed above or otherwise, is used to determine the completion indicators, this information is recorded along with the document set associated with each task.

As noted, user processing system 25 analyzes user activity as users 40 engage with web portal system 42, and generally includes an activity tracking system 26, a task determination system 28 and a progress analysis system 30. Activity tracking system 26 tracks each user's activity when they visit web portal system 42 or otherwise engage with CRM system 46. This may be accomplished by keeping a record of each document viewed by a visitor, a count of how many times the document was viewed, a time stamp of when the document was last viewed, etc.

Moreover, activity tracking system 26 tracks all user activity, including activity from previous visits. Activity history database 34 may be utilized to store activity history for each user 40 for each visit. Aging may be applied to remove old activity from the record after a sufficient period of time has elapsed. Activity tracking system 26 may utilize any mechanism for recognizing a user across multiple sessions, e.g., using cookies, a login process, an email address, etc.

FIG. 3 depicts an example in which user activity has been recorded for the characterized documents shown in FIG. 2. In this example, it can be seen that the user 40 viewed “Descriptions and Features” three times, “Specifications” two times, and “Accessories” once. Obviously, the manner in which user activity is stored and collected can be done in any now known or later developed technique, and FIG. 3 is depicted as one example.

Referring again to FIG. 1, task determination system 28 determines which task a user 40 is engaged in while visiting the site. This may be done in any manner. If the user 40 has interacted with an item defined as a trigger (e.g., a start page, etc.), a task is considered to have been started. Sometimes a trigger may be sufficient to determine the task is underway, but under many circumstances, a trigger may not exist that uniquely identifies a task. In these cases, a user's activity must be compared against the “signature” of each task and a calculation of how closely the activity matches each signature is performed. The calculation may apply a certain threshold of documents viewed from the total number of core documents that comprise a task, select the task with the largest portion of its document set already viewed by the user 40, take into account viewing multiple documents in a certain order, etc. The closest match to a signature identifies the task, since in a user-driven series of document views, the user 40 may be feeling his or her way towards some goal with a series of attempts to get on a successful path. For example, when a customer views the main page for a personal computer model, and then views its specifications page, the customer might be trying to purchase that computer, or might be trying to determine which wireless protocols are supported before buying a wireless network—only by observing further steps can a better determination be made. Task determination system 28 allows the administrator 36 to determine whether to identify both possible tasks as underway (with one fading away as more information becomes known) or to delay identification until one task or the other is clearly underway.

In addition, incrementally applying the most recent documents viewed within the comparison process can be used to distinguish multiple tasks within the same visit from each other. The administrator 36 may choose to record task initiation, progress and completion, or may recalculate tasks in progress whenever needed for reporting, analysis, and dynamic changes to the site during a visit.

Progress analysis system 30 tracks the progress of a user 40 towards completing a task. Over time, the creation of a canonical set of tasks that each tends to be completed after the viewing of certain core documents allows marketers to assess how many customers are in the pipeline and how far into their tasks they are. At a point in time, for example, marketers could identify that there are 300 customers in the midst of purchasing a personal computer and that 30% of them have viewed three or fewer documents of the seven core documents, 55% had viewed between four and six of the core documents, and 15% had viewed all seven, but still had not completed the task.

Various metrics can be employed to assess the progress of customers in completing their tasks, including:

(1) The average number of documents viewed when the task became complete;
(2) The number of documents viewed by each customer identified as performing a task;
(3) The number of times each document was viewed by customers who completed the task;
(4) The percentage of customers who historically complete tasks having viewed different combinations of documents; and
(5) The percentage of customers who complete the task within a certain number of sessions or within a certain period of time.

These metrics and others can be used to assess the revenue and profit value of the pipeline. Historical measures can be used to calculate the probability of customers completing each task based on the documents viewed and the number of sessions in which they viewed them and the period of time over which they viewed them. Applying these probabilities to the customers who have tasks in progress at any point in time, a projection can be made of the number of sales that will eventually be made. (Using the average revenue and profit historically associated with these sales can yield projected revenue and profit for customers in the pipeline.)

As noted above, adaptive marketing system 32 may be utilized to deliver dynamic marketing to a user 40 based on task progress. Understanding where a user 40 is within a task, adaptive marketing system 32 can adapt the user experience, e.g., using dynamic content display techniques, to better persuade users 40 to complete their tasks. Once users 40 are identified as having commenced a particular task (as described above), it is known which documents (from the core set of documents from that task) they have already seen. Marketers can then employ business rules that drive a personalized experience to systematically expose users 40 to more of the core set of documents.

For example, if a customer is identified to have begun the process of purchasing a personal computer, and has viewed the specifications of two different computers, the customer might be prompted to compare the two models in a merchandising box on that second specification page. If that customer is comparing two models from the same product family, the customer might be prompted to view the product family page (if he or she had not already done so).

For each customer, the record of which pages (from the core set) they have seen is used by the business rules to prompt the customer to view some or all of the remaining pages in that core set, based on the business rules. Over time, the conversion results of these prompted viewings of the core set of documents can be used to reevaluate which documents belong in the core set, and to determine when particular core documents have more persuasive power in different contexts. It is likely that patterns will emerge as to what the best document is to show next when a customer has seen a particular set of documents already.

Some customers will be presented (or voluntarily view) most or all of the core documents without converting. At this point, business rules may begin to present documents from the non-core documents associated with the task—those that a significant subset of purchasers have viewed before converting, but which were not found to distinguish task completers from those who do not finish the task. Eventually other related documents from the current subject or other subjects may be offered. For example, some purchasers may need to see the warranty before purchasing, but most tend not to need that information.

When customers have chosen documents that apply to multiple tasks, business rules could present the “next” core documents from more than one of these tasks, allowing the customer to select the document found to be most relevant. That selection then further informs as to which task the customer is performing. In some contexts, the customer could be explicitly asked to choose between the tasks as part of the experience.

While the examples shown here have focused on the example of purchasing a personal computer, completeness measurement system 18 can be applied to any task that can be identified. Customer service and support tasks, tasks for contacting a company offline, or anything else that can be completed on the web can use this method to identify the core information required to induce a user 40 to complete the task.

In addition, while the examples shown here employ a website to present a personalized “next” document, any method that a system can use to present a document can be employed. E-mail re-contact strategies, personalized RSS feeds, initiating outbound calls, the course taken during a single telephone conversation, and other methods can be used to present the “next” piece of information to the customer—the information most likely to persuade completion of the task.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, telephone, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising a completeness measurement system 18 could be created, maintained and/or deployed by a service provider that offers the functions described herein for customers. That is, a service provider could offer to deploy or provide the ability to analyze user behavior as described above.

It is understood that in addition to being implemented as a system and method, the features may be provided as a computer-readable medium storing a program product, which when executed, enables computer system 10 to provide a completeness measurement system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for measuring completeness of a task, comprising:
a task definition system for associating subsets of documents available via a content delivery system with a plurality of tasks;
a tracking system for tracking which documents have been viewed by a user;
a task determination system for determining which of the plurality of tasks the user is engaged in performing; and
a progress analysis system for analyzing a progress the user has achieved towards completing the task.

2. The system of claim 1, wherein the content delivery system comprises a website.

3. The system of claim 1, further comprising an adaptive marketing system that dynamically presents content to the user based on an analysis of the progress the user has achieved towards completing the task.

4. The system of claim 1, further comprising a system for characterizing documents into categories.

5. The system of claim 1, wherein the task definition system includes a system for defining a signature for each task.

6. The system of claim 1, wherein the task definition system includes a system for defining task triggers for each task.

7. The system of claim 1, wherein the task definition system includes a system for defining a completion indicator for each task.

8. The system of claim 1, wherein the activity tracking system tracks a date, time and frequency of views of a document by the user.

9. The system of claim 1, wherein each document consists of an element selected from the group consisting of: a web page, a link, an advertisement, an email, an RSS feed, a graphic item, a multimedia item, a content item, and a text message.

10. A method of measuring completeness of a task, comprising:
associating subsets of documents available via a content delivery system with a plurality of tasks;
tracking which documents have been viewed by a user;
determining which of the plurality of tasks the user is engaged in performing; and
analyzing a progress the user has achieved towards completing the task.

11. The method of claim 10, wherein the content delivery system comprises a website.

12. The method of claim 10, further comprising dynamically presenting content to the user based on an analysis of the progress the user has achieved towards completing the task.

13. The method of claim 10, further comprising characterizing documents into categories.

14. The method of claim 10, further comprising:
defining a signature for each task;
defining a task trigger for each task; and
defining a completion indicator for each task.

15. The method of claim 10, wherein the tracking tracks a date, time and frequency that a document was viewed by the user.

16. The method of claim 10, wherein each document consists of an element selected from the group consisting of: a web page, a link, an advertisement, an email, an RSS feed, a graphic item, a multimedia item, a content item of any type (including but not limited to a graphic or multimedia item), and a text message.

17. A computer readable medium having a computer program product stored thereon for measuring completeness of a task, comprising:
program code for associating subsets of documents available via a content delivery system with a plurality of tasks;
program code for tracking which documents have been viewed by a user;
program code for determining which of the plurality of tasks the user is engaged in performing; and
program code for analyzing a progress the user has achieved towards completing the task and for outputting a set of results.

18. The computer readable medium of claim 17, wherein the content delivery system comprises a website.

19. The computer readable medium of claim 17, further comprising program code for dynamically presenting content to the user based on an analysis of the progress the user has achieved towards completing the task.

20. The computer readable medium of claim 17, further comprising
program code for defining a signature for each task;
program code for defining a task trigger for each task; and
program code for defining a completion indicator for each task.

21. The computer readable medium of claim 17, wherein the program code for tracking tracks a date, time and frequency that a document was viewed by the user.

22. A method for deploying a system for measuring completeness of a task, comprising:
providing a computer infrastructure being operable to:
associate subsets of documents available via a content delivery system with a plurality of tasks;
track which documents have been viewed by a user;
determine which of the plurality of tasks the user is engaged in performing; and
analyze a progress the user has achieved towards completing the task and for outputting a set of results.
